(19) United States
(12) Patent Application Publication
(10) Pub. No.: US 2011/0234767 A1
(43) Pub. Date: Sep. 29, 2011

(54) STEREOSCOPIC IMAGING APPARATUS

(75) Inventor: Kentaro Tokiwa, Saitama (JP)

(73) Assignee: FUJIFILM CORPORATION, Tokyo (JP)

(21) Appl. No.: 13/074,674

(22) Filed: Mar. 29, 2011

(30) Foreign Application Priority Data
Mar. 29, 2010 (JP) P2010-075493

(51) Int. Cl. H04N 13/02

(52) U.S. Cl. 348/47; 348/E13.074

(57) ABSTRACT

A stereoscopic imaging apparatus capable of obtaining a stereoscopic image suitable for a photographic scene is provided. A First imaging section and a second imaging section has a single-eye 3D sensor which includes a plurality of pixel groups for photo-electrically converting photo-electric luminous fluxes having passed through different regions of the pupil of a single photographing optical system. An LSI has a function of double-eye stereoscopic photography in which a viewpoint image obtained by the first imaging section and a viewpoint image obtained by the second imaging section are recorded in a media as a stereoscopic image and a function of single-eye stereoscopic photography in which a plurality of viewpoint images obtained by one of the first imaging section and the second imaging section is recorded in the media as the stereoscopic image.

### BACKGROUND OF THE INVENTION

1. Field of the Invention

The present invention relates to a stereoscopic imaging apparatus, and more particularly, to a technique in which object images having passed through different regions of a photographic lens are imaged onto image sensors to obtain images having different viewpoints.

2. Description of the Related Art

In the related art, one having an optical system as shown in FIG. 18 is known as a stereoscopic imaging apparatus (single-eye stereoscopic photography apparatus) of this kind (see JP2009-527007A).

This optical system has a configuration in which object images having passed through different regions in the horizontal direction of a main lens 1 and a relay lens 2 are pupil-split by a mirror 4 and are imaged onto image sensors 7 and 8 through imaging lenses 5 and 6, respectively.

FIGS. 19A to 19C show split states of an image imaged onto an image sensor depending on a difference between front-focus, in-focus (best focus), and back-focus. In order to compare the differences in the split state depending on focusing, the minor 4 shown in FIG. 18 is omitted in FIGS. 19A to 19C.

Among the pupil-split images, images that are in focus as shown in FIG. 19B are imaged (match) at the same position on the image sensor, whereas images that are front and back focused shown in FIGS. 19A and 19C are imaged (separate) at different positions on the image sensor.

Therefore, by obtaining object images which are pupil-split in the horizontal direction using the image sensors 7 and 8, it is possible to obtain a left viewpoint image and a right viewpoint image (namely, 3D image) of which the parallaxes are different depending on an object distance.

JP2009-168995A relates to a focus detection technique and discloses a configuration in which pupil-splitting is performed inside one lens by a deflector and diaphragm (detection of a defocus amount) is performed based on the split image information.

WO2006/054518 discloses a display apparatus having a configuration in which stereoscopic display and planar display are switched.

### SUMMARY OF THE INVENTION

However, there is a case where it is difficult to obtain a stereoscopic image suitable for a photographic scene.

For example, when photographing a long-range object, there is a case where it is difficult for a single-eye stereoscopic photography apparatus of the related art to increase a parallax amount of a stereoscopic image. Moreover, when the lens zoom magnification is small, there is a case where it is difficult for the single-eye stereoscopic photography apparatus of the related art to increase the parallax amount of a stereoscopic image. Although it may be possible to design so that the parallax amount increases in the cases of long-range photography and small zoom magnification, in that case, the parallax amount increases too much in the cases of macro (short-range) photography and large zoom magnification.

The present invention has been made in view of the above-described problems, and an object of the present invention is to provide a stereoscopic imaging apparatus capable of obtaining a stereoscopic image appropriate for a photographic scene.

In order to attain the objects, according to an aspect of the present invention, there is provided a stereoscopic imaging apparatus including: first and second imaging sections that image an object; and a controlling section that controls the first and second imaging sections to obtain a stereoscopic image, wherein at least one of the first and second imaging sections has an image sensor which includes a plurality of pixel groups for photo-electrically converting photo-electric luminous fluxes having passed through different regions of a pupil of a single photographing optical system for each of the pixel groups, and wherein the controlling section has a function of double-eye stereoscopic photography in which a viewpoint image obtained by the first imaging section and a viewpoint image obtained by the second imaging section are recorded in a recording medium as the stereoscopic image and a function of single-eye stereoscopic photography in which a plurality of viewpoint images obtained by an imaging section which includes the plurality of pixel groups among the first and second imaging sections is recorded in the recording medium as the stereoscopic image. That is, since the stereoscopic imaging apparatus has both the function of single-eye stereoscopic photography and the function of double-eye stereoscopic photography, it is possible to obtain a stereoscopic image suitable for a photographic scene. The “different regions of a pupil of a single photographing optical system” as used herein refers to arbitrary split regions which are pupil-split in an arbitrary direction of a single photographing optical system, for example, in the horizontal or vertical direction and which do not overlap.

In one embodiment of the present invention, it is preferable that the first imaging section has the photographing optical system and a general image sensor photo-electricfor photo-electrically converting the luminous fluxes having passed through the photographing optical system without pupil-splitting the luminous fluxes. That is, during planar (2D) photography, a high-quality 2D image can be obtained using the first imaging section having a general image sensor. During stereoscopic (3D) photography, the single-eye stereoscopic photography and double-eye stereoscopic photography can be selected. In this way, it is possible to obtain an appropriate image in accordance with a photographic scene.

In one embodiment of the present invention, it is preferable that the first and second imaging sections have the photographing optical system and an image sensor for single-eye stereoscopic photography.

According to another aspect of the present invention, there is provided a stereoscopic imaging apparatus including: first and second imaging sections that image an object; a controlling section that controls the first and second imaging sections to obtain a stereoscopic image; a main optical system which is a photographing optical system shared by the first and second imaging sections; and a beam splitter which is formed of a mirror or a prism that splits luminous fluxes having passed through the main optical system, wherein the first and second imaging sections have an imaging optical system that images the luminous fluxes split by the beam splitter and an image sensor which includes a plurality of pixel groups photo-electricfor photo-electrically converting the luminous fluxes having passed through different regions of the imaging optical system for each of the pixel groups, wherein the controlling section has a function of double-eye stereoscopic photography in which a viewpoint image obtained by the first imaging section and a viewpoint image obtained by the second imaging section are recorded in a recording medium as the stereoscopic image and a function of single-eye stereoscopic photography in which a plurality of viewpoint images obtained by an imaging section which includes the plurality of pixel groups among the first and second imaging sections is recorded in the recording medium as the stereoscopic image.

In one embodiment of the present invention, it is preferable that the controlling section determines which one of the single-eye stereoscopic photography and the double-eye stereoscopic photography will be performed based on a photographing condition of the photographing optical system.

In one embodiment of the present invention, it is preferable that the controlling section determines which one of the single-eye stereoscopic photography and the double-eye stereoscopic photography will be performed based on at least one of an optical zoom magnification and object distance.

In one embodiment of the present invention, it is preferable that the controlling section determines which one of the single-eye stereoscopic photography and the double-eye stereoscopic photography will be performed by determining whether a parallax amount of the stereoscopic image in at least one of the single-eye stereoscopic photography and the double-eye stereoscopic photography is suitable or not.

In one embodiment of the present invention, it is preferable that the stereoscopic imaging apparatus further includes a storage section that stores table information representing the relationship between the photographing condition and the switching of the single-eye stereoscopic photography and the double-eye stereoscopic photography, and the controlling section selects a photography mode corresponding to the photographing condition among the single-eye stereoscopic photography and the double-eye stereoscopic photography based on the table information.

In one embodiment of the present invention, it is preferable that the stereoscopic imaging apparatus further includes a storage section that stores table information representing the relationship between the photographing condition of the photographing optical system and a plurality of pixel groups used for obtaining the stereoscopic image among the plurality of pixel groups of the first imaging section and the plurality of pixel groups of the second imaging section, and the controlling section selects the pixel groups used for obtaining the stereoscopic image among the plurality of pixel groups of the first imaging section and the plurality of pixel groups of the second imaging section based on the table information.

In one embodiment of the present invention, it is preferable that the controlling section calculates a parallax amount of an object image at a non-focusing position of the stereoscopic image based on at least a pupil-splitting baseline length in the imaging section, an object distance at a focusing position, and an object distance at a non-focusing position and switches between the single-eye stereoscopic photography and the double-eye stereoscopic photography based on the parallax amount.

In one embodiment of the present invention, it is preferable that the controlling section calculates a parallax amount of an object image at a non-focusing position of the stereoscopic image based on at least a pupil-splitting baseline length in the imaging section, a focal distance, an object distance at a focusing position, and an aperture value and switches between the single-eye stereoscopic photography and the double-eye stereoscopic photography based on the parallax amount.

In one embodiment of the present invention, it is preferable that a pupil-splitting baseline length in the first imaging section is different from a pupil-splitting baseline length in the second imaging section, and when performing the single-eye stereoscopic photography, the controlling section switches between the first imaging section and the second imaging section to generate the stereoscopic image, thus changing the parallax amount of the stereoscopic image. That is, it is possible to select an imaging section suitable for a photographic scene from a plurality of imaging sections of which the baseline lengths between the pixel groups are different, thus obtaining a stereoscopic image having a stereoscopic effect.

For example, it is preferable that the controlling section selects the imaging section based on a photographing condition of the photographing optical system.

For example, it is preferable that the stereoscopic imaging apparatus further includes a photography mode select input section that selects and inputs a photography mode, and the controlling section selects the imaging section based on the selected photography mode.

For example, the baseline length of the pupil-split is a center-to-center distance between the different regions of the photographing optical system in a plane perpendicular to an optical axis of the photographing optical system.

For example, the image sensor including the plurality of pixel groups includes a microlens that focuses luminous fluxes having passed through the photographing optical system, a photodiode that receives the luminous fluxes having passed through the microlens, and a light shielding member that partially shields a light receiving surface of the photodiode, and wherein the pupil-splitting baseline length is determined by a diameter of the photographing optical system and a light shielding amount of the light receiving surface of the photodiode by the light shielding member.

For example, the image sensor including the plurality of pixel groups includes a microlens that focuses luminous fluxes having passed through the photographing optical system, and a photodiode that receives the luminous fluxes having passed through the microlens, an optical axis of the microlens is arranged so as to be shifted from an optical axis of the photodiode, and the pupil-splitting baseline length is determined by a diameter of the photographing optical system and a shift amount between the optical axis of the microlens and the optical axis of the photodiode.

In one embodiment of the present invention, it is preferable that the stereoscopic imaging apparatus further includes a photography mode select input section that selects and inputs a photography mode, and the controlling section determines which one of the single-eye stereoscopic photography and the double-eye stereoscopic photography will be performed in accordance with the selected photography mode.

In one embodiment of the present invention, it is preferable that the controlling section determines that the double-eye stereoscopic photography is to be performed when the selected photography mode is a still picture mode and determines that the single-eye stereoscopic photography is to be performed when the selected photography mode is a motion picture mode.

In one embodiment of the present invention, it is preferable that the controlling section determines that the single-eye stereoscopic photography is to be performed when the selected photography mode is a macro mode.

In one embodiment of the present invention, it is preferable that the stereoscopic imaging apparatus is capable of obtaining four viewpoint images using the plurality of pixel groups of the first imaging section and the plurality of pixel groups of the second imaging section, and wherein when performing the double-eye stereoscopic photography, the controlling section generates the stereoscopic image based on the four viewpoint images. That is, it is possible to obtain a continuous stereoscopic image imaged from four viewpoints.

In one embodiment of the present invention, it is preferable that the stereoscopic imaging apparatus is capable of obtaining four viewpoint images using the plurality of pixel groups of the first imaging section and the plurality of pixel groups of the second imaging section, and wherein when performing the double-eye stereoscopic photography, the controlling section selects viewpoint images that form the stereoscopic image from the four viewpoint images, thus changing the parallax amount of the stereoscopic image.

In one embodiment of the present invention, it is preferable that the stereoscopic imaging apparatus further includes a tilt sensor that detects a tilt of a main body of the stereoscopic imaging apparatus in a plane perpendicular to the optical axis of the photographing optical system of the first and second imaging sections. It is also preferable that the first imaging section has a plurality of pixel groups for vertical photography divided in a first direction on the light receiving surface on which the luminous fluxes having passed through the photographing optical system are received, the second imaging section has a plurality of pixel groups for horizontal photography divided in a second direction perpendicular to the first direction on the light receiving surface on which the luminous fluxes having passed through the photographing optical system are received, and when performing the single-eye stereoscopic photography, the controlling section selects one of single-eye stereoscopic photography for vertical photography using the plurality of pixel groups of the first imaging section and single-eye stereoscopic photography for horizontal photography using the plurality of pixel groups of the second imaging section based on the tilt detected by the tilt sensor.

In one embodiment of the present invention, it is preferable that the controlling section interpolates information on pixels lacking in a viewpoint image obtained by a pixel group used for generating the stereoscopic image using a viewpoint image obtained by a pixel group which is not used for generating the stereoscopic image among the plurality of pixel groups of the first imaging section and the plurality of pixel groups of the second imaging section.

In one embodiment of the present invention, it is preferable that when switching between single-eye stereoscopic photography and double-eye stereoscopic photography, the controlling section performs control so that the angle of view in the single-eye stereoscopic photography is identical to that in the double-eye stereoscopic photography.

In one embodiment of the present invention, it is preferable that when switching between single-eye stereoscopic photography and double-eye stereoscopic photography, the controlling section performs control so that a parallax amount of the stereoscopic image changes continuously.

In one embodiment of the present invention, it is preferable that the controlling section performs multi-viewpoint processing based on a plurality of viewpoint images obtained by the first and second imaging sections.

According to the aspects of the present invention, it is possible to provide a stereoscopic imaging apparatus capable of obtaining a stereoscopic image suitable for a photographic scene.

### BRIEF DESCRIPTION OF THE DRAWINGS

FIG. 1 is a block diagram of a stereoscopic imaging apparatus.

FIGS. 2A to 2C show configuration examples of a single-eye 3D sensor.

FIG. 3 shows one main pixel and one sub-pixel.

FIGS. 4A to 4C show a main part of FIG. 3 in an enlarged scale.

FIG. 5 is a schematic block diagram of a main part of a stereoscopic imaging apparatus according to a first embodiment.

FIG. 6 is a schematic flowchart showing the flow of a photographing process according to a second embodiment.

FIGS. 7A and 7B are schematic flowcharts showing the flow of a photographing process according to a third embodiment.

FIG. 8 is a perspective plan view showing a main part structure of a stereoscopic imaging apparatus according to a fourth embodiment.

FIG. 9 is a schematic block diagram of a main part of a stereoscopic imaging apparatus according to a fifth embodiment.

FIG. 10 is a schematic block diagram of a main part of a stereoscopic imaging apparatus according to a sixth embodiment.

FIG. 11 is a schematic block diagram of a main part of a stereoscopic imaging apparatus according to a seventh embodiment.

FIG. 12 is a schematic block diagram of a main part of a stereoscopic imaging apparatus according to an eighth embodiment.

FIG. 13 is a schematic diagram illustrating a baseline length of an imaging section.

FIG. 14 illustrates an example of table information in a ninth embodiment.

FIG. 15 is a schematic flowchart showing the flow of a photographing process according to a tenth embodiment.

FIG. 16 is an explanation diagram of a parallax amount.

FIG. 17 illustrates a parallax amount calculating method.

FIG. 18 shows an example of an optical system of a single-eye stereoscopic imaging apparatus according to the related art.

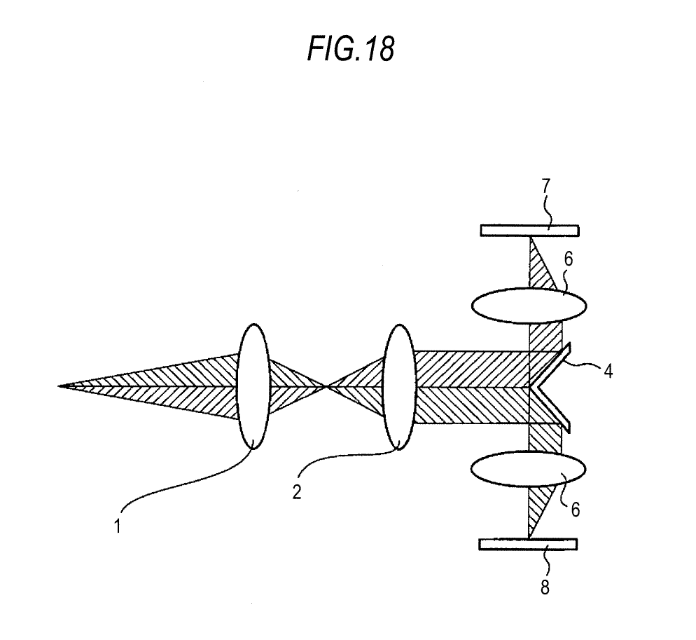

FIGS. 19A to 19C illustrate the principle of how an image with a phase difference is imaged by a single-eye stereoscopic imaging apparatus.

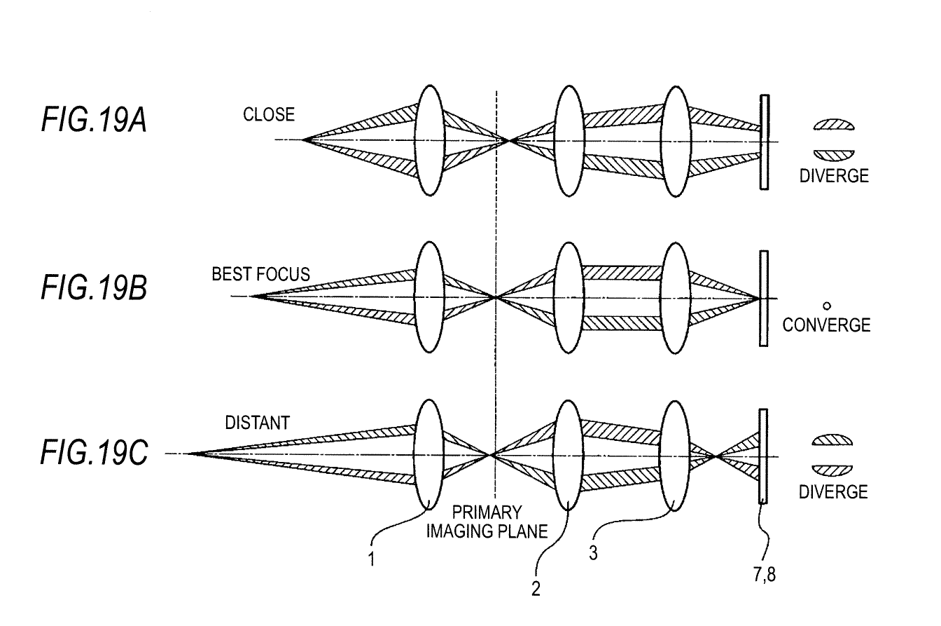

### DESCRIPTION OF THE PREFERRED EMBODIMENTS

Hereinafter, embodiments of the present invention will be described with reference to the accompanying drawings.

Overall Configuration of Imaging Apparatus

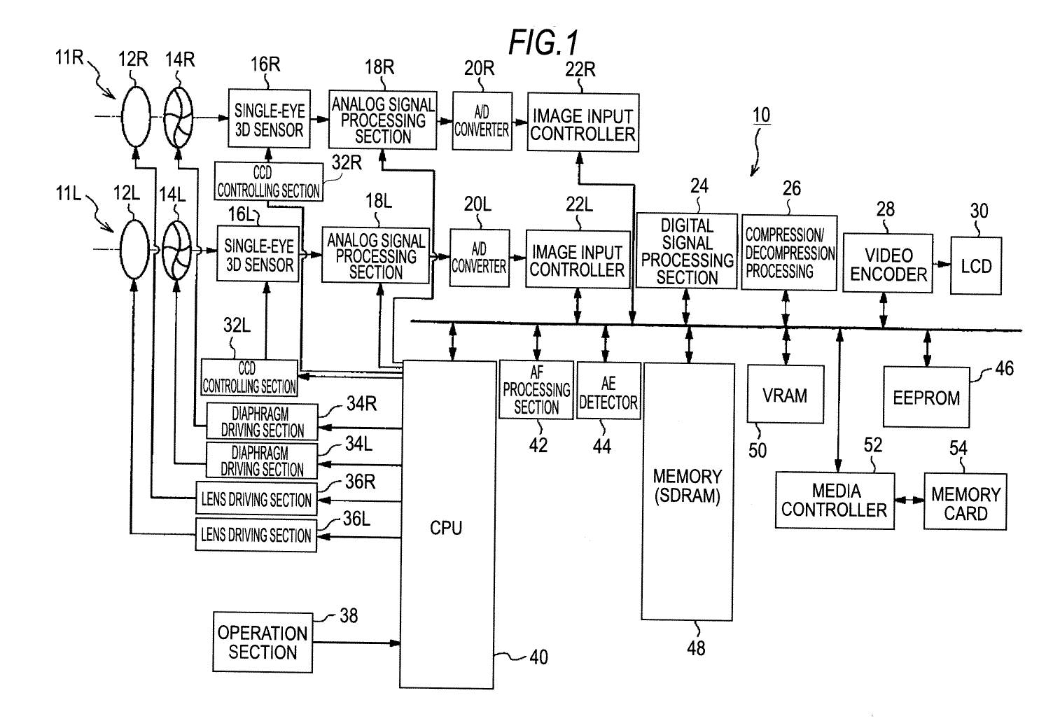

FIG. 1 is a block diagram showing an embodiment of a stereoscopic imaging apparatus 10 according to the present invention.

The stereoscopic imaging apparatus 10 records photographed images in a memory card 54 (hereinafter also referred to as “media”), and an overall operation of the apparatus is controlled by a central processing unit (CPU) 40.

The stereoscopic imaging apparatus 10 has an operation section 38 such as, for example, a shutter button, a mode dial, a playback button, a MENU/OK key, a cross key, and a BACK key. Signals from the operation section 38 are input to the CPU 40. Then, the CPU 40 controls circuits in the stereoscopic imaging apparatus 10 based on the input signals to perform various control operations such as, for example, lens driving control, diaphragm driving control, photographing control, image processing control, recording/playback control of image data, and display control of a stereoscopic liquid crystal monitor 30.

The shutter button is an operation button for inputting an instruction to start photographing and is configured by a two-stroke switch which has an S1 switch that is switched ON by a half push and an S2 switch that is switched ON by a full push. The mode dial is a selector that selects one of the following photography modes: a 2D mode, a 3D mode, an auto mode, a manual mode, a scene mode for photographing persons, landscapes, night scenes, a macro mode, a motion picture mode, and a parallax preferential mode according to the present invention.

The playback button is a button for switching to a playback mode to display still pictures or motion pictures of the stereoscopic images (3D images) and planar images (2D images) which have been captured and recorded in the liquid crystal monitor 30. The MENU/OK key is an operation key which serves as a menu button for issuing an instruction to display a menu on the screen of the liquid crystal monitor 30 and also serves as an OK button for issuing an instruction to confirm and execute a selected content. The cross key is an operation section that inputs an instruction as to the four directions up, down, left, and right and serves as a button (a cursor movement operation section) for selecting an item from the menu screen and instructing the selection of various setting items from each menu. Moreover, the up/down key of the cross key serves as a zoom switch at the time of photographing or a playback zoom switch in the playback mode, and the left/right key serves as a page scroll (forward/backward scroll) button in the playback mode. The BACK key is used to delete a desired item such as a selected item and cancel an instruction or return to a previous operation state.

In the photography mode, an image light representing an object is imaged onto a light receiving surface of a solid-state image sensor 16 (16R, 16L) (hereinafter referred to as a “single-eye 3D sensor”) which is a phase-difference image sensor through a photographic lens 12 (12R, 12L), which includes a focusing lens and zoom lens, and a diaphragm 14 (14R, 14L). The photographic lens 12 (12R, 12L) is driven by a lens driving section 36 (36R, 36L) that is controlled by the CPU 40 and controls focusing, zooming, and the like. The diaphragm 14 (14R, 14L) is made up of five aperture leaf blades, for example, and driven by a diaphragm driving section 34 (34R, 34L) that is controlled by the CPU 40. For example, the diaphragm 14 (14R, 14L) is controlled in six steps of the aperture value (AV) from F1.4 to F11 on an AV basis.

The CPU 40 controls the diaphragm 14 (14R, 14L) using the diaphragm driving section 34 (34R, 34L) and also controls a charge storage section time (shutter speed) in the single-eye 3D sensor 16 and readout of image signals from the single-eye 3D sensor 16 using a CCD controlling section 32 (32R, 32L).

Configuration Example of Single-Eye 3D Sensor

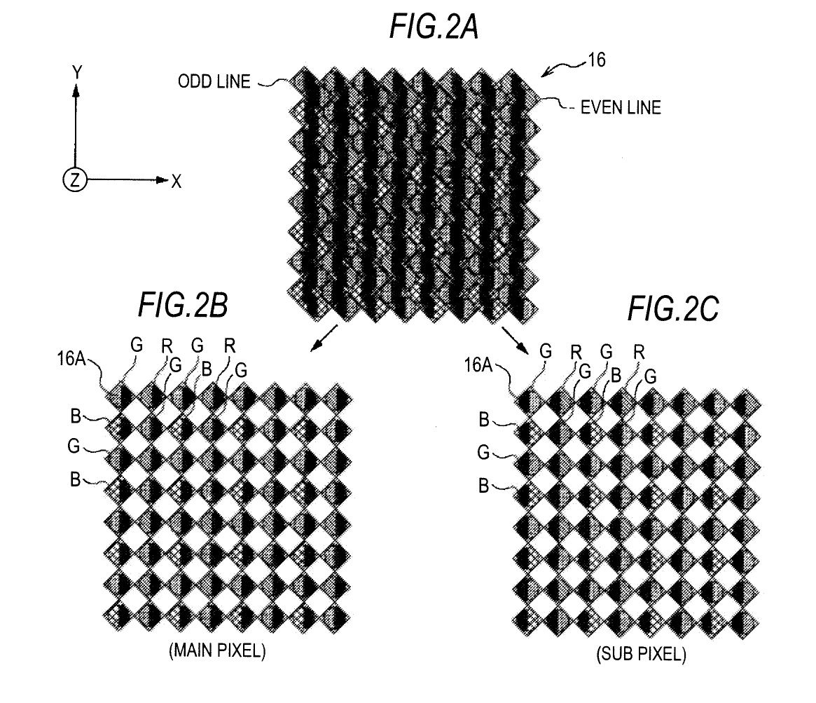

FIGS. 2A to 2C show configuration examples of the single-eye 3D sensor 16.

The single-eye 3D sensor 16 has odd-line pixels (main pixels) and even-line pixels (sub-pixels) each being arranged in a matrix form, so that two frames of image signals having been subjected to photo-electric conversion in these main and sub-pixels can be independently read out.

As shown in FIGS. 2A to 2C, on the odd lines (1, 3, 5, . . . ) of the single-eye 3D sensor 16, among the pixels having color filters of R (red), G (green), and B (blue), a line of a pixel arrangement of G R, G, R and a line of a pixel arrangement of B, B, G are alternately arranged. On the other hand, on the even lines (2, 4, 6, . . . ) similarly to the odd lines, a line of a pixel arrangement of G R, G R and a line of a pixel arrangement of B, G B, G are alternately arranged. The pixels on the odd lines are shifted in the arrangement direction by an amount of ½ pitch with respect to the pixels on the even lines.

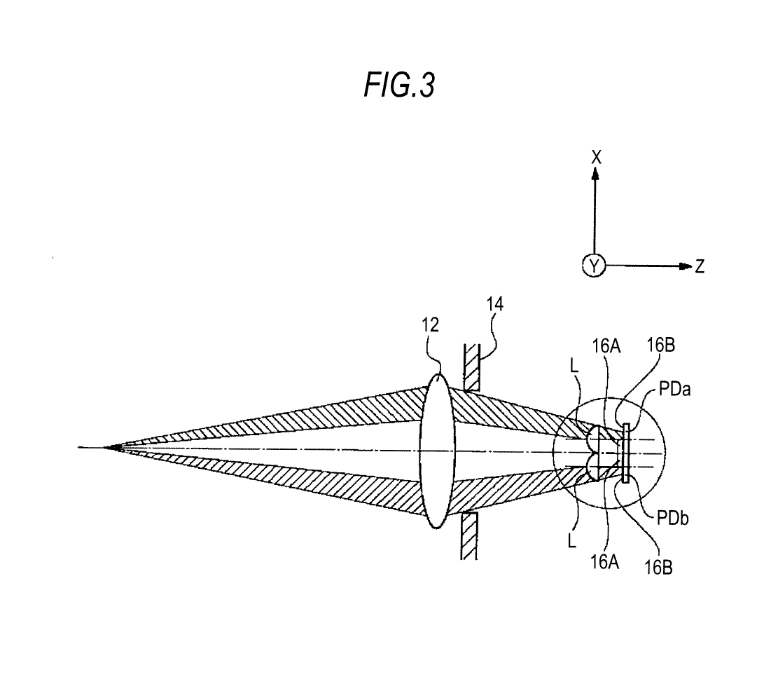

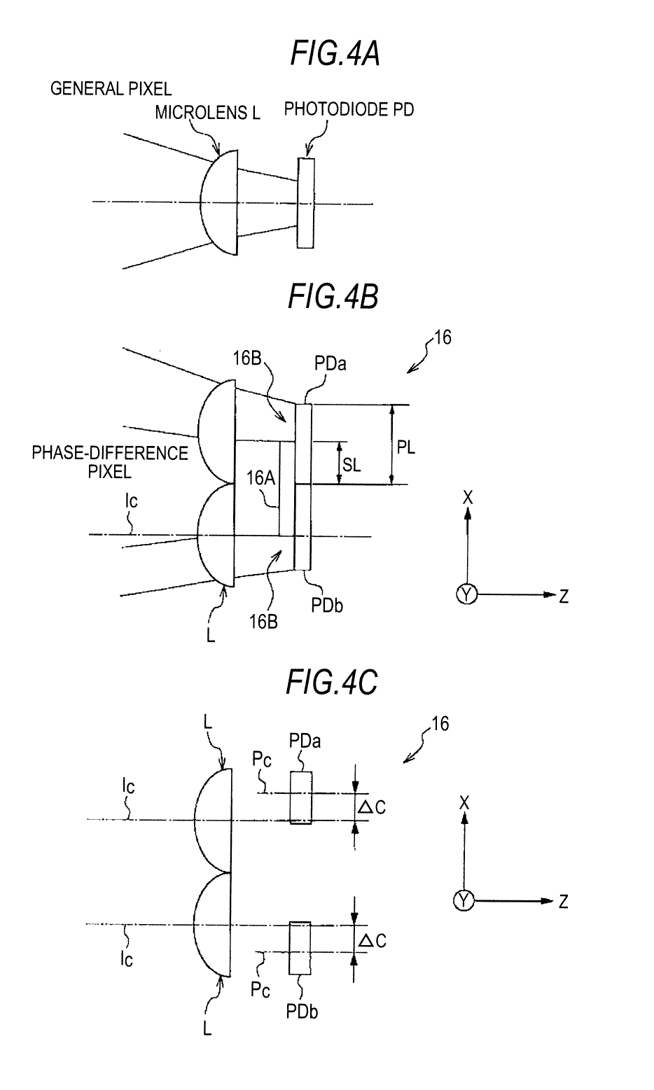

FIG. 3 shows the photographic lens (photographing optical system) 12, the diaphragm 14, and one main pixel PDa and one sub-pixel PDb of the single-eye 3D sensor 16, and FIGS. 4A to 4C show a main part of FIG. 3 in an enlarged scale.

As shown in FIG. 4A, in a general CCD, luminous fluxes passing through an exiting pupil enter the pixel (photodiode PD) through a microlens L without being blocked.

In contrast, the single-eye 3D sensor 16 shown in FIG. 4B includes a microlens L that focuses luminous fluxes having passed through the photographic lens 12, a photodiode PD (main pixel PDa and sub-pixel PDb) that receives the luminous fluxes having passed through the microlens L, and a light shielding member 16A that partially shields the light receiving surface of the photodiode PD. In this example, the light shielding member 16A shields the right or left half of the light receiving surface of the main pixel PDa and the sub-pixel PDb. That is, the light shielding member 16A functions as a pupil splitting member.

In the single-eye 3D sensor 16 described above, although the region (the right or left half) where luminous fluxes are blocked by the light shielding member 16A is different from main pixel PDa to sub-pixel PDb, the present invention is not limited to this. For example, the light shielding member 16A may not be provided, and the microlens L and the photodiode PD (PDa, PDb) may be shifted relative to each other in the horizontal direction (pupil-splitting direction) as shown in FIG. 4C so that the optical axis Ic of the microlens L is arranged so as to be shifted from the optical axes Pc of the photodiodes PDa and PDb, whereby luminous fluxes entering the photodiode PD are limited. Moreover, one microlens may be provided for two pixels (main pixel and sub-pixel) so that luminous fluxes entering each pixel are limited.

Returning to FIG. 1, the signal charge stored in the single-eye 3D sensor 16 (16R, 16L) is read out as a voltage signal corresponding to the signal charge based on a readout signal supplied from the CCD controlling section 32. The voltage signal read out from the single-eye 3D sensor 16 (16R, 16L) is supplied to an analog signal processing section 18 (18R, 18L), in which the R, G, and B signals for each pixel are subjected to sample-and-hold processing and amplified by a gain (corresponding to an ISO sensitivity) designated by the CPU 40 and are then supplied to an A/D converter 20 (20R, 20L). The A/D converter 20 (20R, 20L) converts the R, G, and B signals supplied sequentially into digital R, G, and B signals and outputs them to an image input controller 22 (22R, 22L).

The first imaging section 11R is formed by the first photographic lens 12R, the first diaphragm 14R, the first single-eye 3D sensor 16R, the first analog signal processing section 18R, the first A/D converter 20R, the first image input controller 22R, the first CCD controlling section 32R, the first diaphragm driving section 34R, and the first lens driving section 36R. Moreover, the second imaging section 11L is formed by the second photographic lens 12L, the second diaphragm 14L, the second single-eye 3D sensor 16L, the second analog signal processing section 18L, the second A/D converter 20L, the second image input controller 22L, the second CCD controlling section 32L, the second diaphragm driving section 34L, and the second lens driving section 36L.

A digital signal processing section 24 performs predetermined signal processing on the digital image signals input through the image input controller 22. The signal processing may include offset processing, gain control processing (for example, white balance correction and sensitivity correction), gamma-correction processing, synchronization processing, YC processing, and sharpness correction.

An EEPROM 46 is a nonvolatile memory in which a camera control program, defect information of the single-eye 3D sensor 16, various kinds of parameters, tables, and programmed diagrams used for image processing, and a plurality of parallax preferential programmed diagrams according to the present invention are stored.

Here, as shown in FIGS. 2B and 2C, main pixel image data read out from the main pixels on the odd lines of the single-eye 3D sensor 16 are processed as left viewpoint image data, and sub-pixel image data read out from the sub-pixels on the even lines are processed as right viewpoint image data.

The left viewpoint image data and right viewpoint image data (3D image data) processed by the digital signal processing section 24 are input to a VRAM 50. The VRAM 50 includes an A region and a B region in which 3D image data representing 3D images corresponding to one page are stored. In the VRAM 50, the 3D image data representing the 3D images corresponding to one page are alternately overwritten to the A and B regions. Among the A and B regions of the VRAM 50, 3D image data being overwritten are read out from a region other than the region where 3D image data are overwritten. The 3D image data read out from the VRAM 50 are encoded by a video encoder 28 and output to the stereoscopic liquid crystal monitor 30 provided on the rear side of a camera. In this way, the 3D object image is displayed on the display screen of the liquid crystal monitor 30.

Although the liquid crystal monitor 30 is a stereoscopic display section capable of displaying stereoscopic images (left viewpoint image and right viewpoint image) as directional images having predetermined directivity with aid of a parallax barrier, the present invention is not limited to this. For example, the liquid crystal monitor 30 may be one which uses a lenticular lens and one which enables users to see the left viewpoint image and right viewpoint image by wearing special glasses such as polarization glasses or liquid crystal shutter glasses.

When the shutter button of the operation section 38 is at the first pressed stage (half push), the single-eye 3D sensor 16 starts an AF operation and an AE operation so that the focusing lens in the photographic lens 12 is controlled so as to be at the focusing position by the lens driving section 36. Moreover, when the shutter button is at the half push state, the image data output from the A/D converter 20 are taken into an AE detector 44.

The AE detector 44 integrates the G signals of the whole screen or integrates the G signals with a different weighting factor applied to the central portion of the screen and the surrounding portion and outputs the integrated value to the CPU 40. Then, the CPU 40 calculates the brightness (photographic EV value) of an object from the integrated value input from the AE detector 44. Based on the photographic EV value, the CPU 40 determines the aperture value of the diaphragm 14 and the electronic shutter (shutter speed) of the single-eye 3D sensor 16 in accordance with a predetermined programmed diagram. Finally, the CPU 40 controls the diaphragm 14 using the diaphragm driving section 34 based on the determined aperture value and controls the charge storage section time in the single-eye 3D sensor 16 using the CCD controlling section 32 based on the determined shutter speed.

The AF processing section 42 is a section that performs contrast AF processing or phase-difference AF processing. When the contrast AF processing is performed, the AF processing section 42 extracts high-frequency components of image data in a predetermined focus region among at least one of the left viewpoint image data and the right viewpoint image data and integrates the high-frequency components to calculate an AF estimate representing a focused state. Then, the focusing lens in the photographic lens 12 is controlled so that the AF estimate amounts to the maximum, whereby the AF control is performed. On the other hand, when the phase-difference AF processing is performed, the AF processing section 42 detects a phase difference between image data corresponding to the main pixel and sub-pixel in a predetermined focus region among the left viewpoint image data and right viewpoint image data and calculates a defocus amount based on information representing the phase difference. Then, the focusing lens in the photographic lens 12 is controlled so that the defocus amount becomes 0, whereby the AF control is performed.

When the AE operation and the AF operation are finished, and the shutter button is at the second pressed stage (full push), in response to the pressing, the two pieces of image data of the left viewpoint image (main pixel image) and the right viewpoint image (sub-pixel image) corresponding to the main pixel and sub-pixel output from the A/D converter 20 are input from the image input controller 22 to a memory (SDRAM) 48 and temporarily stored therein.

The two pieces of image data temporarily stored in the memory 48 are appropriately read out by the digital signal processing section 24, in which the read image data are subjected to predetermined signal processing such as generation processing (YC processing) of luminance data and chromaticity data of the image data. The image data (YC data) having been subjected to YC processing are stored in the memory 48 again. Subsequently, the two pieces of YC data are output to a compression/decompression processing section 26 and subjected to predetermined compression processing such as JPEG (Joint Photographic Experts Group) and are then stored in the memory 48 again.

From the two pieces of YC data (compressed data) stored in the memory 48, a multipicture file (MP file: a file format wherein a plurality of images are connected) is generated, and the MP file is read out by a media controller 52 and recorded in a memory card 54.

The stereoscopic imaging apparatus 10 having the basic configuration as shown in FIG. 1 includes the first and second imaging sections 11R and 11L that image an object and the CPU 40 as a controlling section that controls the first and second imaging sections 11R and 11L. At least one of the first and second imaging sections 11R and 11L has an image sensor (the single-eye 3D sensor 16) which includes a plurality of pixel groups for photo-electrically converting photo-electric luminous fluxes having passed through different regions of the exiting pupil of the single photographic lens 12 (12R, 12L). The CPU 40 has a function of double-eye stereoscopic photography in which a viewpoint image (image information) obtained by the first imaging section 11R and a viewpoint image (image information) obtained by the second imaging section 11L are recorded in the memory card 54 as a stereoscopic image and a function of single-eye stereoscopic photography in which a plurality of viewpoint images (a plurality of pieces of image information) obtained by an imaging section which includes the plurality of pixel groups among the first and second imaging sections 11R and 11L is recorded in the memory card 54 as the stereoscopic image.

In the following description, various embodiments of the stereoscopic imaging apparatus according to the present invention will be described.

### First Embodiment

First, a first embodiment will be described.

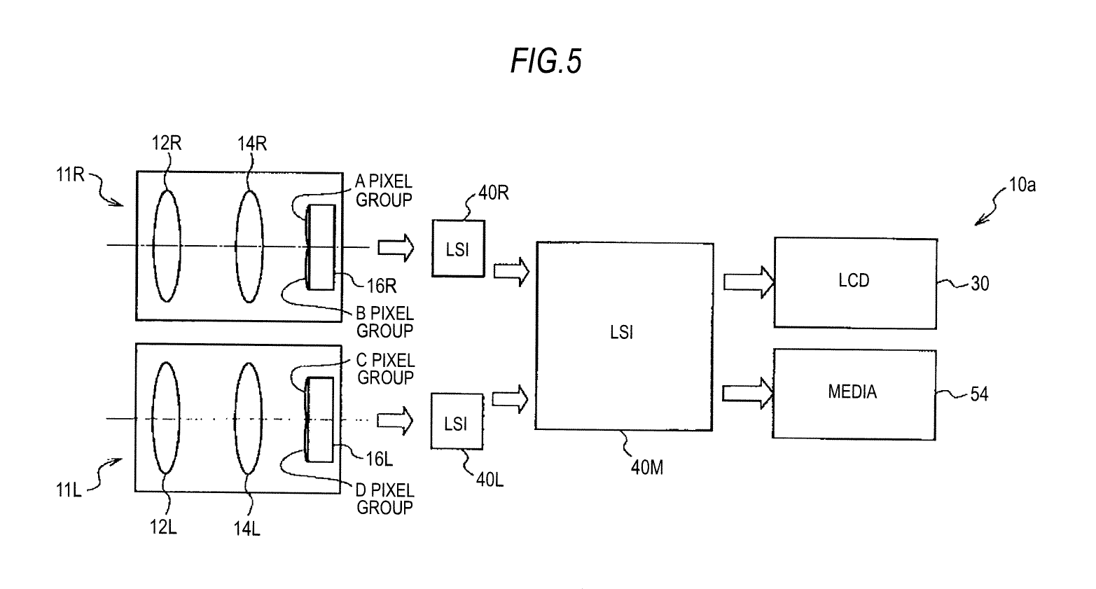

FIG. 5 is a schematic block diagram of a main section of a stereoscopic imaging apparatus 10a according to a first embodiment. In FIG. 5, the first and second imaging sections 11R and 11L have a single photographic lens 12R, 12L and a single-eye 3D sensor 16R, 16L which includes a plurality of pixel groups for photo-electrically converting photo-electric luminous fluxes having passed through different regions of the exiting pupil of the photographic lens 12R, 12L. The first single-eye 3D sensor 16R has an A pixel group (main pixel group) and a B pixel group (sub-pixel group). The second single-eye 3D sensor 16L has a C pixel group (main pixel group) and a D pixel group (sub-pixel group). The arrangement of the pixel groups is the same as that shown and described in FIGS. 2A to 2C. The structure of the respective pixels is the same as that shown and described in FIG. 3 and FIGS. 4A to 4C.

Three LSIs 40R, 40L, and 40M shown in FIG. 5 correspond to the CPU 40 in FIG. 1. The first LSI 40R controls the first imaging section 11R, the second LSI 40L controls the second imaging section 11L, and the third LSI 40M controls the whole stereoscopic imaging apparatus and controls the selection and execution of double-eye stereoscopic photography and single-eye stereoscopic photography. When performing double-eye stereoscopic photography, stereoscopic image information is generated using a first viewpoint image obtained by a pixel group (for example, the A pixel group) of the first imaging section 11R and a second viewpoint image obtained by a pixel group (for example, the D pixel group) of the second imaging section 11L and recorded in the memory card 54. Moreover, when performing single-eye stereoscopic photography, the stereoscopic image is generated using the first and second viewpoint image information obtained by a plurality of pixel group of one of the first and second imaging sections 11R and 11L and recorded in the memory card 54.

For example, the LSI 40 performs single-eye stereoscopic photography when the photography mode is in a macro (short-range) mode and performs double-eye stereoscopic photography when the photography mode is in a normal mode.

Various modifications as set below can be made in this embodiment.

According to a first modification, by the control of the LSI 40M, information lacking in a viewpoint image (pixel information) obtained by a pixel group used for generating a stereoscopic image is interpolated using a viewpoint image (image information) obtained by a pixel group which is not used for generating the stereoscopic image among the plurality of pixel groups of the first imaging section 11R and the plurality of pixel groups of the second imaging section 11L. For example, when the stereoscopic image is generated using the viewpoint image obtained by the A pixel group of the first imaging section 11R and the viewpoint image obtained by the D pixel group of the second imaging section, information (position information, pixel value, parallax map, or the like of occlusion pixels) about occlusion pixels (pixels in which it is unable to detect correspondence points between viewpoint images of a stereoscopic image) is calculated, and the information is added to the stereoscopic image.

According to a second modification, by the control of the LSI 40M, switching between the single-eye stereoscopic photography and the double-eye stereoscopic photography is performed smoothly during capturing of motion pictures. For example, control wherein the angle of view in the single-eye stereoscopic photography is made identical to that in the double-eye stereoscopic photography, control wherein the parallax amount of the stereoscopic image is changed continuously, and other control may be performed. Specifically, a zoom magnification, an aperture value, an image cropping range, and the like may be adjusted so as to change gradually.

According to a third modification, multi-viewpoint processing is performed based on a plurality of viewpoint images obtained by the first and second imaging sections 11R and 11L. For example, when the stereoscopic image is generated using the viewpoint image obtained by the first imaging section 11R and the viewpoint image obtained by the second imaging section 11L, an intermediate viewpoint image at an imaginary viewpoint between the first and second imaging sections 11R and 11L may be added to the stereoscopic image. In order to produce the intermediate viewpoint image, correspondence points between a plurality of viewpoint images are detected, a parallax map representing a parallax amount between the correspondence points is generated, and an intermediate viewpoint image is produced based on the plurality of viewpoint images and the parallax map.

### Second Embodiment

Next a second embodiment will be described.

The main part configuration of the stereoscopic imaging apparatus according to the second embodiment is the same as that of the first embodiment shown in FIG. 5, except that imaging control by the LSI 40M is different. The LSI 40M of this embodiment acquires the photographing condition of the photographic lens 12 and determines which one of the single-eye stereoscopic photography and the double-eye stereoscopic photography will be performed by determining whether a parallax amount is suitable or not based on the photographing condition.

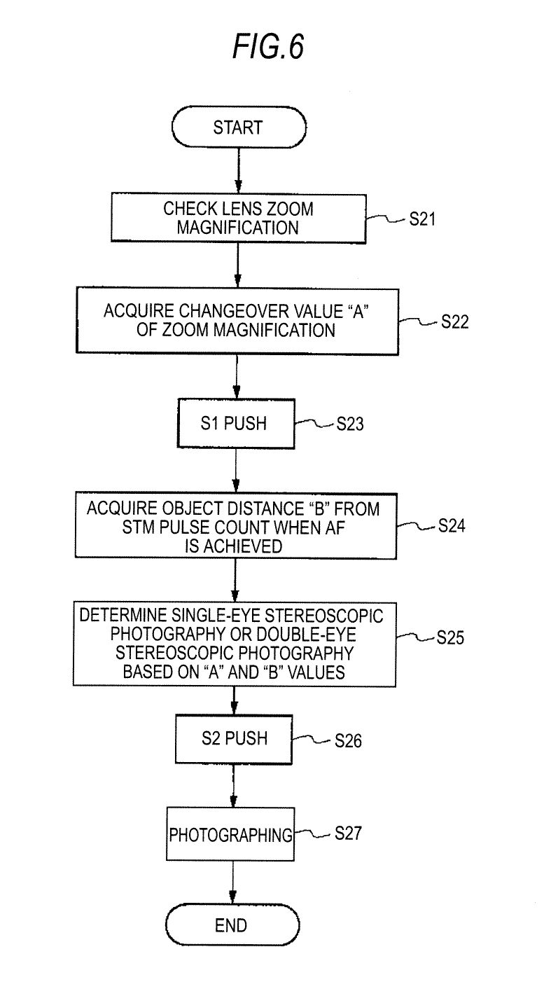

FIG. 6 is a schematic flowchart showing the flow of an example of a photographing process according to the second embodiment. This process is executed by the LSI 40M.

In step S21, the LSI 40M checks a zoom magnification (optical magnification) that is presently set in the photographic lens 12 (12R and 12L).

In step S22, the LSI 40M acquires the zoom magnification (changeover value A) to be set in the photographic lens 12. In this example, the zoom magnification is acquired from the memory 48 (or the EEPROM 46). The zoom magnification is designated and input by the operation section 38 and stored in the memory 48 (or the EEPROM 46).

In step S23, a S1 push (half push of the shutter button) is received.

In step S24, the LSI 40M acquires an object distance B. In this example, the object distance B is calculated based on a S™ (stepping motor) pulse count when AF (autofocus) is achieved.

In step S25, the LSI 40M determines whether the parallax amount of the stereoscopic image in the single-eye stereoscopic photography and the double-eye stereoscopic photography is suitable or not based on the zoom magnification (changeover value A) and the object distance B and determines which one of the double-eye stereoscopic photography and the single-eye stereoscopic photography will be performed. The suitability of the parallax amount may be determined based on any one of the zoom magnification A and the object distance B. The suitability of the parallax amount may be determined for any one of the single-eye stereoscopic photography and the double-eye stereoscopic photography.

The parallax amount in the stereoscopic image increases as the zoom magnification of the photographic lens 12 increases and is different depending on the magnitude of the object distance. Moreover, the parallax amount in the stereoscopic image is larger in the double-eye stereoscopic photography than in the single-eye stereoscopic photography. For example, the LSI 40M determines whether or not the photographic scene is hard to increase the parallax amount in the stereoscopic image generated by the single-eye stereoscopic photography based on the zoom magnification A and the object distance B. When it is determined that the photographic scene is hard to increase the parallax amount, the LSI 40M determines to perform the double-eye stereoscopic photography. When it is determined that the photographic scene is easy to increase the parallax amount, the LSI 40M determines to perform the single-eye stereoscopic photography. Alternatively, the LSI 40M determines whether or not the photographic scene is likely to increase the parallax amount in the stereoscopic image generated by the double-eye stereoscopic photography too much and determines to perform the single-eye stereoscopic photography when it is determined that the photographic scene increases the parallax amount too much and determines to perform the double-eye stereoscopic photography when it is determined that the photographic scene does not increase the parallax amount too much. For example, the photography method is determined by calculating the parallax amount and comparing the parallax amount with a threshold value.

In step S26, a S2 push (full push of the shutter button) is received.

In step S27, the LSI 40M performs stereoscopic photography determined in step S25 among the single-eye stereoscopic photography and the double-eye stereoscopic photography.

### Third Embodiment

Next, a third embodiment will be described.

The main part configuration of the stereoscopic imaging apparatus according to the third embodiment is the same as that of the first embodiment shown in FIG. 5, except that imaging control by the LSI 40M is different. The LSI 40M of this embodiment determines which one of the single-eye stereoscopic photography and the double-eye stereoscopic photography will be performed by determining whether a parallax amount is suitable or not based on the photography mode selected and input by the operation section 38.

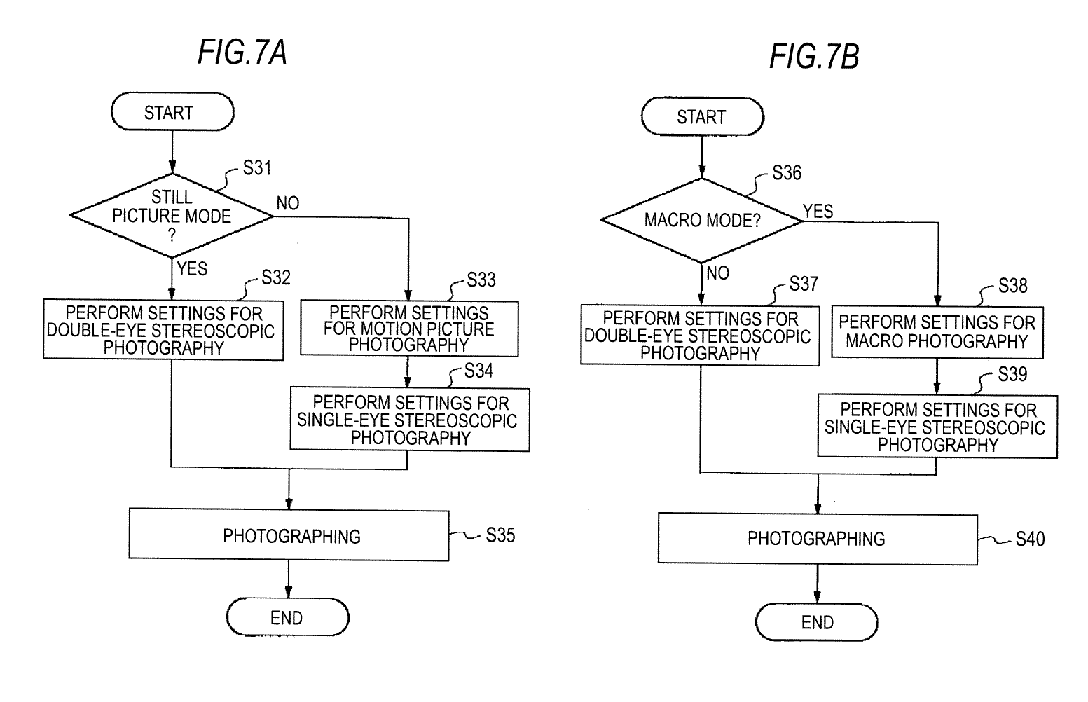

FIG. 7A is a schematic flowchart showing the flow of an example of a photographing process according to the third embodiment.

It is assumed that as default settings, settings of still picture photography and double-eye stereoscopic photography have been finished when this process starts.

In step S31, the LSI 40M determines whether the photography mode is in the still picture mode or the motion picture mode. When the photography mode is in the still picture mode, the LSI 40M performs settings for the still picture mode in step S32. When the photography mode is in the motion picture mode, the LSI 40M performs settings for the motion picture mode in step S33 and performs setting for the single-eye stereoscopic photography in step S34.

In step S35, the set photography is performed.

FIG. 7B is a schematic flowchart showing the flow of another example of a photographing process according to the third embodiment.

It is assumed that as default settings, settings of normal photography and double-eye stereoscopic photography have been finished when this process starts.

In step S36, the LSI 40M determines whether the photography mode is in the macro mode or the normal mode. When the photography mode is in the normal mode, the LSI 40M performs settings for the double-eye stereoscopic photography in step S37. When the photography mode is in the macro mode, the LSI 40M performs settings for the macro mode in step S38 and performs setting for the single-eye stereoscopic photography in step S39.

In step S40, the set photography is performed.

### Fourth Embodiment

Next, a fourth embodiment will be described.

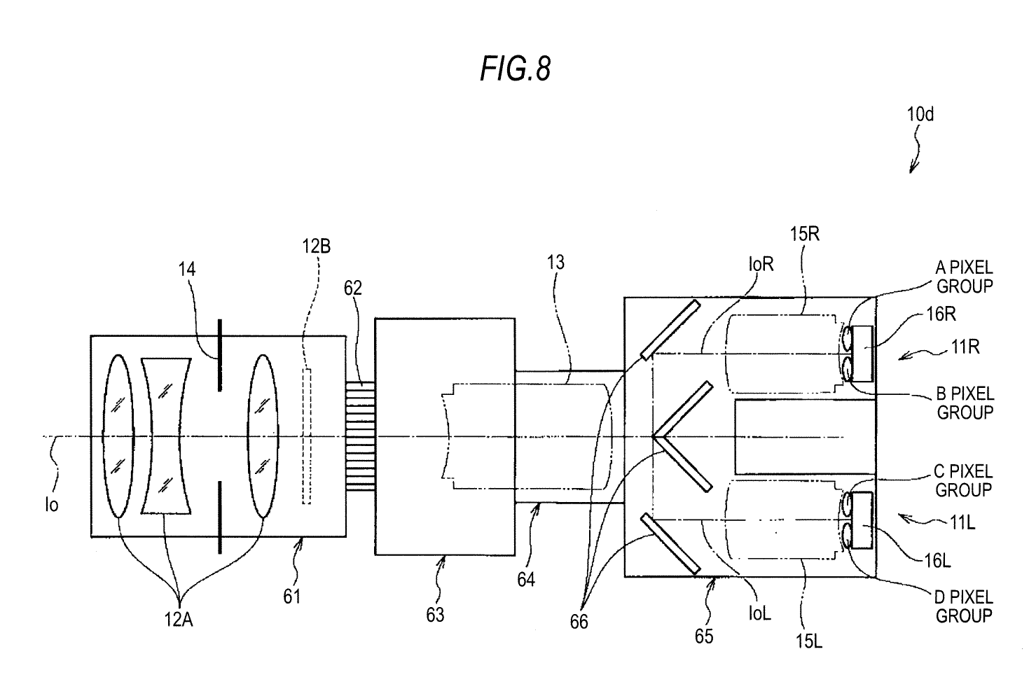

FIG. 8 is a perspective plan view showing a main part structure of a stereoscopic imaging apparatus 10d according to the fourth embodiment. As shown in FIG. 8, the stereoscopic imaging apparatus 10d of this embodiment includes a main optical system unit 61 which has a main lens 12A (corresponding to the photographic lens 12R, 12L in FIG. 1) and a diaphragm 14 (corresponding to the diaphragm 14R, 14L in FIG. 1). The main lens 12A includes a focusing lens and a zoom lens. The main optical system unit 61 is shared by the first and second imaging sections 11R and 11L. Although not shown in FIG. 8, the configuration on the right side of the single-eye 3D sensors 16R and 16L, namely the configuration on the right side of the single-eye 3D sensors 16R and 16L in FIG. 1 is the same as the basic configuration shown in FIG. 1. Moreover, the single-eye 3D sensors 16R and 16L of this example have the same configuration as those shown in FIGS. 2A to 2C to FIGS. 4A to 4C. In the following description, only the difference from the basic configuration shown in FIG. 1 will be described.

In FIG. 8, the main optical system unit 61 including the main lens 12A and the diaphragm 14 is mounted on a lens barrel body front 63 with a circular lens mount 62 disposed therebetween. The lens barrel body front 63 is connected to a lens barrel body back 65 through a lens barrel body intermediate portion 64. A relay lens 13 is disposed in the lens barrel body intermediate portion 64. In the lens barrel body back 65, a mirror 66, two imaging lenses 15R and 15L, and two single-eye 3D sensors 16R and 16L are disposed.

In FIG. 8, the optical axis Io of the main optical system unit 61 is divided into two left and right optical axes IoR and IoL by the mirror 66, and luminous fluxes having passed through a pupil 12B of the main optical system unit 61 are split to the left and right sides by the mirror 66. That is, the mirror 66 causes the luminous fluxes having passed through the right half region of the pupil 12B of the main optical system unit 61 to enter the first imaging lens 15R and also causes the luminous fluxes having passed through the left half region of the pupil 12B of the main optical system unit 61 to enter the second imaging lens 15L. The luminous fluxes entering the first imaging lens 15R are imaged as an object image on the light receiving surface of the first single-eye 3D sensor 16R, and the luminous fluxes entering the second imaging lens 15L are imaged as an object image on the light receiving surface of the second single-eye 3D sensor 16L.

The first single-eye 3D sensor 16R includes an A pixel group (main pixel group) and a B pixel group (sub-pixel group) for photo-electrically converting the photo-electric luminous fluxes having passed through different regions (the right and left half regions) of the first imaging lens 15R. The second single-eye 3D sensor 16L includes a C pixel group (main pixel group) and a D pixel group (sub-pixel group) for photo-electrically converting the photo-electric luminous fluxes having passed through different regions (the right and left half regions) of the second imaging lens 15L. That is, the luminous fluxes having passed through the pupil 12B of the main optical system unit 61 are split by the mirror 66 and are further split by the respective single-eye 3D sensors 16R and 16L (specifically, the light shielding member 16A shown in FIG. 4B) themselves and finally enter the pixel groups (A to D pixel groups) at four viewpoints in total. The arrangement of the pixel groups in the respective single-eye 3D sensors 16R and 16L is the same as that shown and described in FIGS. 2A to 2C.

The photographing process can be performed by the LSI 40M as described in the second or third embodiment.

Although a case where the luminous fluxes having passed through the main optical system unit 61 are split by the mirror has been described as an example, the luminous fluxes may be split by a prism.

### Fifth Embodiment

Next, a fifth embodiment will be described.

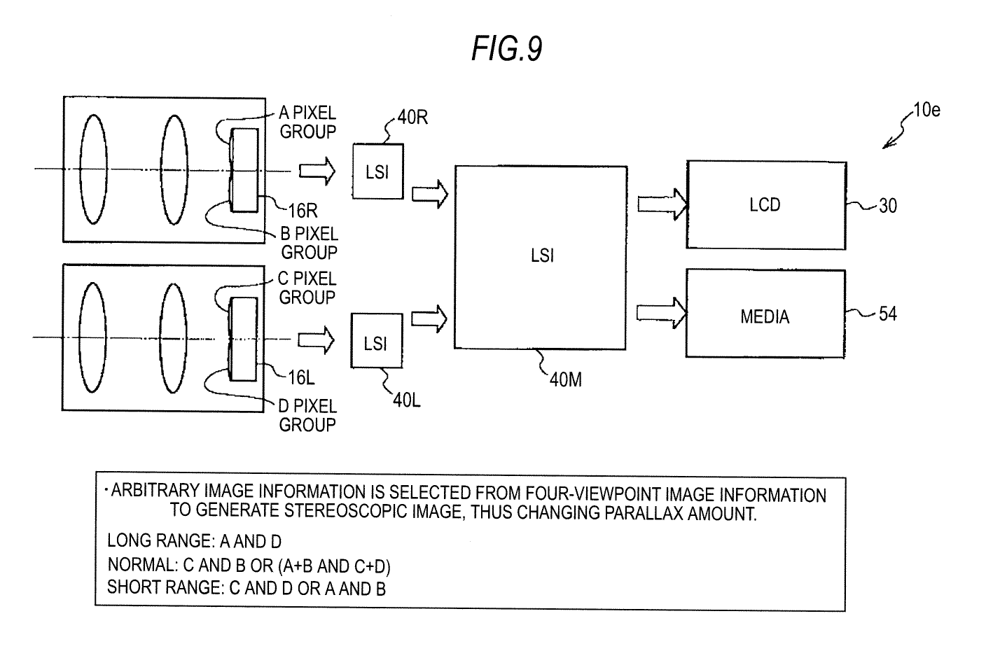

FIG. 9 is a schematic block diagram of a main part of a stereoscopic imaging apparatus 10e according to the fifth embodiment. In the following description, only the difference from that of the first embodiment will be described.

In this embodiment, when performing the double-eye stereoscopic photography, the LSI 40M changes the parallax amount of the stereoscopic image by selecting two viewpoint images imaged from two viewpoints which constitute the stereoscopic image from four viewpoint images (image information) imaged from four viewpoints in total which can be generated by the four pixel groups in total (the A and B pixel groups of the first single-eye 3D sensor 16R and the C and D pixel groups of the second single-eye 3D sensor 16L). That is, the LSI 40M selects which two of the four viewpoint images will be used for generating the stereoscopic image in accordance with the magnitude of a parallax (an intended parallax amount) of the stereoscopic image to be generated.

For example, the LSI 40M determines whether the object distance belongs to a long range (Large), a normal range (Medium), or a short range (Small) and generates the stereoscopic image by selecting two-viewpoint image information generated by the A and D pixel groups when the object distance is the long range, selecting two viewpoint images (two-viewpoint image) generated by the B and C pixel groups when the object distance is the normal range, and selecting two viewpoint images (two-viewpoint image) generated by the C and D pixel groups (or the A and B pixel groups) when the object distance is the short range. That is, the parallax amount of the stereoscopic image is changed in accordance with the difference in the baseline length between the pixel groups A-D, B-C, and C-D (or A-B).

The two-viewpoint stereoscopic image may be generated based on four viewpoint images. For example, when the object distance is the normal distance, image information obtained by the A pixel group and image information obtained by the B pixel group may be combined to produce a first combined image, image information obtained by the C pixel group and image information obtained by the D pixel group may be combined to produce a second combined image, and a stereoscopic image may be formed based on the first and second combined images. For example, correspondence points between a plurality of pieces of image information are detected to produce a parallax map, and an image is reconstructed (combined) based on the plurality of pieces of image information and the parallax map.

### Sixth Embodiment

Next, a sixth embodiment will be described.

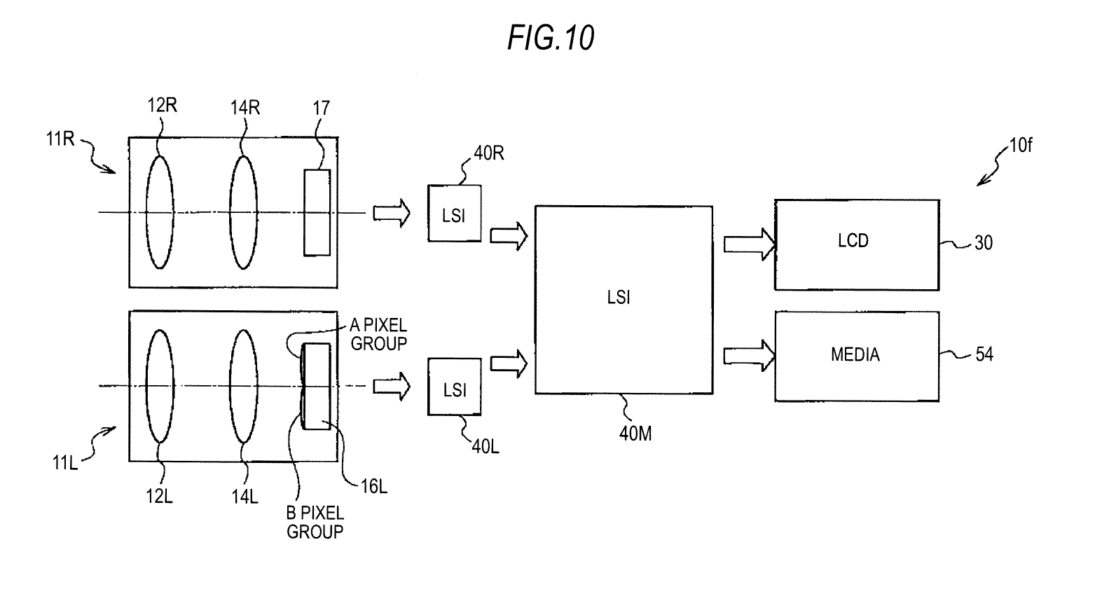

FIG. 10 is a schematic block diagram of a main part of a stereoscopic imaging apparatus 10f according to the sixth embodiment.

In FIG. 10, the first imaging section 11R has the photographic lens 12R, the diaphragm 14R, and a general sensor 17 in which general pixels are arranged. The general sensor 17 is formed of a CCD sensor or the like, for example. General pixels shown in FIG. 4A are arranged on the light receiving surface of the general sensor 17. The general pixel is different from the phase difference pixel shown in FIG. 4B, in that it does not have the light shielding member 16A and performs photo-electric conversion on the luminous fluxes having passed through the photographic lens 12R without performing pupil-splitting on the luminous fluxes. That is, the exiting pupil of the photographic lens 12R is not split.

The second imaging section 11L is the same as that described in the first embodiment and has the photographic lens 12L, the diaphragm 14L, and the single-eye 3D sensor 16L. The single-eye 3D sensor 16L has a plurality of pixel groups photo-electricfor photo-electrically converting the luminous fluxes having passed through different regions of the pupil of the photographic lens 12L.

In the case of performing single-eye stereoscopic photography, the LSI 40M of this example records right-viewpoint image information obtained by the A pixel group (the main pixel group) of the second imaging section 11L and left-viewpoint image information obtained by the B pixel group (the sub-pixel group) of the second imaging section 11L in the media (the memory card 54) as a stereoscopic image.

In the case of performing double-eye stereoscopic photography, the LSI 40M of this example records right-viewpoint image information obtained by the general pixel group of the first imaging section 11R and left-viewpoint image information obtained by one pixel group (for example, the B pixel group) of the plurality of pixel groups (the A and B pixel groups) of the second imaging section 11L in the media (the memory card 54) as a stereoscopic image.

In the case of the 3D photography (stereoscopic photography) mode, the LSI 40M determines which one of the single-eye stereoscopic photography and the double-eye stereoscopic photography will be performed. The selection of the double-eye stereoscopic photography and the single-eye stereoscopic photography can be made in various ways. For example, they may be selected in accordance with a photographing condition relating to the parallax amount such as the optical zoom magnification or the object distance as described in the second embodiment. Moreover, for example, they may be selected in accordance with the photography mode as described in the third embodiment. For example, the single-eye stereoscopic photography is performed when the photography mode is in the macro mode and the double-eye stereoscopic photography is performed when the photography mode is in the normal mode.

In the case of the 2D (planar) photography mode, the LSI 40M acquires a planar image using the first imaging section 11R and records the image in the memory card 54.

### Seventh Embodiment

Next, a seventh embodiment will be described.

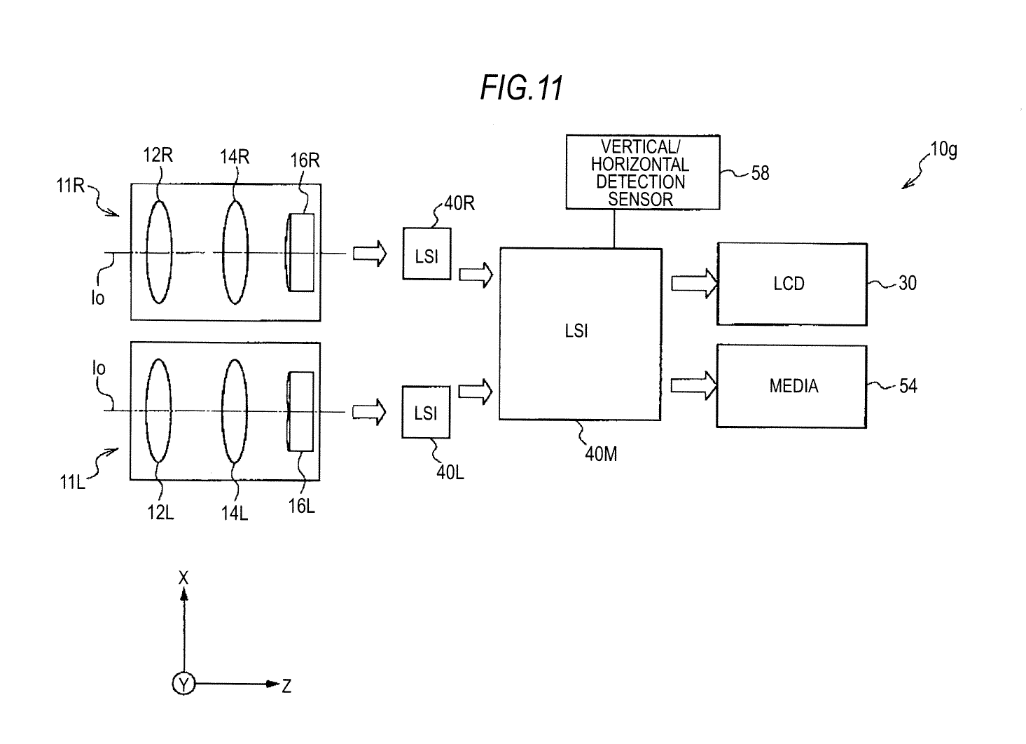

FIG. 11 is a schematic block diagram of a stereoscopic imaging apparatus 10g according to the seventh embodiment.

The stereoscopic imaging apparatus 10g of this embodiment includes a vertical/horizontal detection sensor 58 (tilt sensor) that detects a tilt of the main body of the stereoscopic imaging apparatus 10g in a plane (a plane defined by the orthogonal x and y axes in the drawing) perpendicular to the optical axis Iₒ of the photographic lenses 12R and 12L, thus detecting whether the stereoscopic imaging apparatus 10g is in the vertical photography mode or in the horizontal photography mode.

Moreover, the first imaging section 11R has a plurality of pixel groups which is divided (pupil-split) in the vertical direction (the y-axis direction in the drawing). The second imaging section 11L has a plurality of pixel groups which is divided (pupil-split) in the horizontal direction (the x-axis direction in the drawing). In this example, the single-eye 3D sensor 16R of one imaging section HR has a main pixel group and a sub-pixel group for vertical photography which are arranged in such an arrangement that the arrangement shown in FIGS. 2A to 2C is rotated at 90° around the z axis, namely the pixels are divided (pupil-split) in the y-axis direction (vertical direction) on the light receiving surface on which the luminous fluxes having passed through the photographic lens 12R are received. Moreover, the single-eye 3D sensor 16L of the other imaging section 11L has a main pixel group and a sub-pixel group for horizontal photography which are divided in the x-axis direction (horizontal direction) on the light receiving surface on which the luminous fluxes having passed through the photographic lens 12L are received as shown in FIGS. 2A to 2C.

When performing the single-eye stereoscopic photography, the LSI 40M of this embodiment selects one of single-eye stereoscopic photography for vertical photography using the plurality of pixel groups of the single-eye 3D sensor 16R of the first imaging section 11R and single-eye stereoscopic photography for horizontal photography using the plurality of pixel groups of the single-eye 3D sensor 16L of the second imaging section 11L based on the tilt detected by the vertical/horizontal detection sensor 58. That is, when the single-eye stereoscopic photography is performed, and the vertical photography mode is detected by the vertical/horizontal detection sensor 58, the stereoscopic photography for vertical photography is performed using the first imaging section 11R. When the single-eye stereoscopic photography is performed, and the horizontal photography mode is detected by the vertical/horizontal detection sensor 58, the stereoscopic photography for horizontal photography is performed using the second imaging section 11L. When the double-eye stereoscopic photography is performed, the stereoscopic photography for horizontal photography is performed using the first and second imaging sections 11R and 11L.

### Eighth Embodiment

Next, an eighth embodiment will be described.

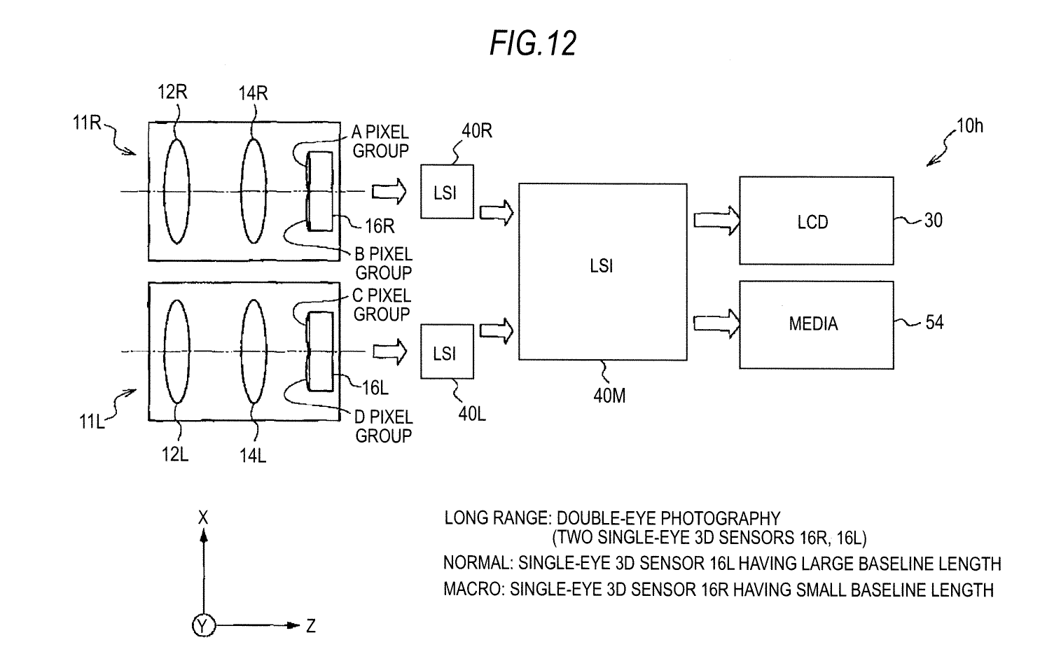

FIG. 12 is a schematic block diagram of a main part of a stereoscopic imaging apparatus 10h according to the eighth embodiment. In the following description, only the difference from the stereoscopic imaging apparatus 10a of the first embodiment shown in FIG. 5 will be described.

The stereoscopic imaging apparatus 10h of this embodiment includes a plurality of imaging sections 11R and 11L having different baseline lengths (separation widths).

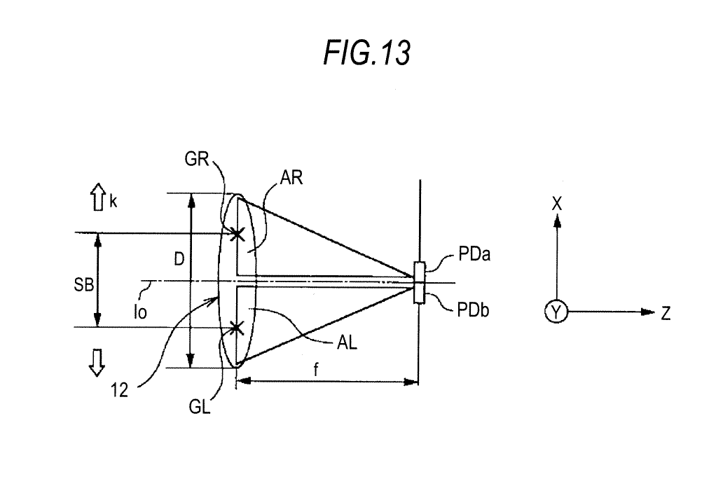

First, the baseline length of the imaging sections 11R and 11L will be described. As shown in the schematic diagram of FIG. 13, a baseline length SB is the distance between the central positions GR and GL of the different pupil-split regions AR and AL of the photographic lens 12. In this specification, the baseline length SB is also referred to as a “pupil-splitting baseline length”. Specifically, the baseline length SB is the distance (|GR-GL|) between the central position GR of an effective area through which the luminous fluxes received by the main pixel PDa among the right half AR (the upper half in the drawing) of the photographic lens 12 pass and the central position GL of an effective area through which the luminous fluxes received by the sub-pixel PDb of the left half AL (the lower half in the drawing) of the photographic lens 12 pass.

The baseline length SB is basically determined by the aperture diameter D (the diameter of the exiting pupil) of the photographic lens 12. That is, basically, SB=D×α. Here, α is a basic coefficient representing the correspondence between the aperture diameter D and the baseline length SB.

The baseline length SB is also determined by the separation amount between the pixels PDa and PDb in the single-eye 3D sensor 16.

For example, in the single-eye 3D sensor 16 shown in FIG. 4B, the baseline length SB is determined by the aperture diameter D of the photographic lens 12 and the light shielding amount (masking amount) of the photodiodes PDa and PDb by the light shielding member 16A. That is, actually, SB=D×α×m, and the separation coefficient m is determined by the effective light receiving width PL of the photodiodes PDa and PDb in FIG. 4B and the light shielding width SL thereof. That is, the separation coefficient m increases as the light shielding width SL in FIG. 4B increases, and the baseline length SB in FIG. 13 extends in the direction indicated by an arrow k.

For example, in the single-eye 3D sensor 16 shown in FIG. 4C, the baseline length SB is determined by the aperture diameter D of the photographic lens 12 and a shift amount Ac (optical axis shift amount) between the optical axis center Ic of the microlens L and the optical axis center Pc of the photodiode PD. That is, actually, SB=D×α×m, and the separation coefficient m is determined by Ac. That is, the separation coefficient m increases as Ac in FIG. 4C increases, and the baseline length SB in FIG. 13 extends in the direction indicated by the arrow k.

In the stereoscopic imaging apparatus 10h of this embodiment, the separation coefficient m has different values from between the A and B pixel groups (the main pixel and sub-pixel groups) in the single-eye 3D sensor 16R of the first imaging section 11R to between the C and D pixel groups (the main pixel and sub-pixel groups) in the single-eye 3D sensor 16L of the second imaging section 11L.

The pixel groups may be separated with a structure different from that shown in FIGS. 4B and 4C. For example, a structure in which only one microlens is provided to the pair of main pixel and sub-pixel to limit luminous fluxes entering the respective pixels may be used. Moreover, the present invention can be applied to when the separation coefficient m=1, namely, even when SB=D×α.

When performing the single-eye stereoscopic photography, the LSI 40M changes the parallax amount of the stereoscopic image by switching between the first imaging section HR and the second imaging section 11L to generate the stereoscopic image.

The imaging sections HR and 11L may be selected based on the photographing condition and may be selected based on the photography mode. The photographing condition includes the zoom magnification of the photographic lens 12, the object distance, and the like. The photography mode includes a macro mode, a normal mode, a still picture mode, and a motion picture mode.

For example, the double-eye stereoscopic photography is performed when the photography mode is in the long-range mode. The single-eye stereoscopic photography is performed using the single-eye 3D sensor 16L having a larger baseline length when the photography mode is in the normal mode. The single-eye stereoscopic photography is performed using the single-eye 3D sensor 16R having a smaller baseline length when the photography mode is in the macro mode.

### Ninth Embodiment

Next, a ninth embodiment will be described.

The main part configuration of the stereoscopic imaging apparatus according to the ninth embodiment is the same as that of the first embodiment shown in FIG. 5, except that imaging control by the LSI 40M is different.

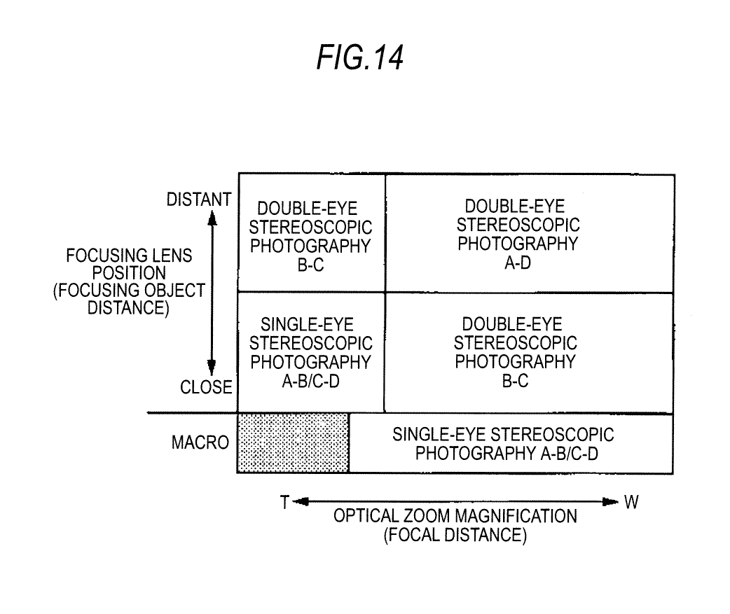

The LSI 40M of this embodiment switches between the single-eye stereoscopic photography and the double-eye stereoscopic photography based on table information stored in the EEPROM 46 of FIG. 1. As shown in FIG. 14, the table information shows the relationship between the photographing condition (in this example, the optical zoom magnification and the object distance) and the switching between the single-eye stereoscopic photography and the double-eye stereoscopic photography.

Next, an example of a photographing process according to the ninth embodiment will be described with reference to the flowchart of FIG. 6. This process is executed by the LSI 40M. In the following description, only the difference from that of the second embodiment will be described.

Steps S21 to S24 are the same as those of the second embodiment.

In step S25, the LSI 40M switches between the single-eye stereoscopic photography and the double-eye stereoscopic photography based on the table information stored in the EEPROM 46.

In the case of a normal photography mode, as shown in FIG. 14, the single-eye stereoscopic photography and the double-eye stereoscopic photography are switched in accordance with a combination of a focusing object distance (a distance to an object focused by a focusing lens) and an optical zoom magnification. When the focusing object distance is in the long range and the optical zoom magnification is on the “T” (Tele) side, the double-eye stereoscopic photography is performed using the B and C pixel groups to obtain a stereoscopic image. When the focusing object distance is in the long range and the optical zoom magnification is on the “W” (Wide) side, the double-eye stereoscopic photography is performed using the A and D pixel groups to obtain a stereoscopic image. On the other hand, when the focusing object distance is in the short range and the optical zoom magnification is on the (Tele) side, the single-eye stereoscopic photography is performed using the A and B pixel groups (or the C and D pixel groups) to obtain a stereoscopic image. On the other hand, when the focusing object distance is in the short range and the optical zoom magnification is on the “W” (Wide) side, the double-eye stereoscopic photography is performed using the B and C pixel groups to obtain a stereoscopic image. The long/short range of the focusing object distance may be determined using the position of the focusing lens, and the magnitude (Tele/Wide) of the optical zoom magnification may be determined using the focal distance (or the position of the zoom lens).

In the case of a macro photography mode, as shown in FIG. 14, the single-eye stereoscopic photography is performed using the A and B pixel groups (or the C and D pixel groups).

Steps S26 and S27 are the same as those of the second embodiment.

As described above, the EEPROM 46 of this embodiment stores the table information representing the relationship between the photographing condition and the switching of the single-eye stereoscopic photography and the double-eye stereoscopic photography, and the LSI 40M of this embodiment selects a photography mode corresponding to the photographing condition among the single-eye stereoscopic photography and the double-eye stereoscopic photography based on the table information. Moreover, the EEPROM 46 of this embodiment stores the table information representing the relationship between the photographing condition and a plurality of pixel groups used for obtaining the stereoscopic image among the plurality of pixel groups of the first imaging section 11R and the plurality of pixel groups of the second imaging section 11L, and the LSI 40M of this embodiment selects the pixel groups used for obtaining the stereoscopic image among the plurality of pixel groups of the first imaging section 11R and the plurality of pixel groups of the second imaging section 11L based on the table information.

### Tenth Embodiment

Next, a tenth embodiment will be described.

The main part configuration of the stereoscopic imaging apparatus according to the tenth embodiment is the same as that of the first embodiment shown in FIG. 5, except that imaging control by the LSI 40M is different.

The LSI 40M of this embodiment calculates a parallax amount of an object image at a non-focusing position of a stereoscopic image based on at least a pupil-splitting baseline length SB, an object distance (focusing object distance) at a focusing position, and an object distance (non-focusing object distance) at a non-focusing position and switches between the single-eye stereoscopic photography and the double-eye stereoscopic photography based on the parallax amount.

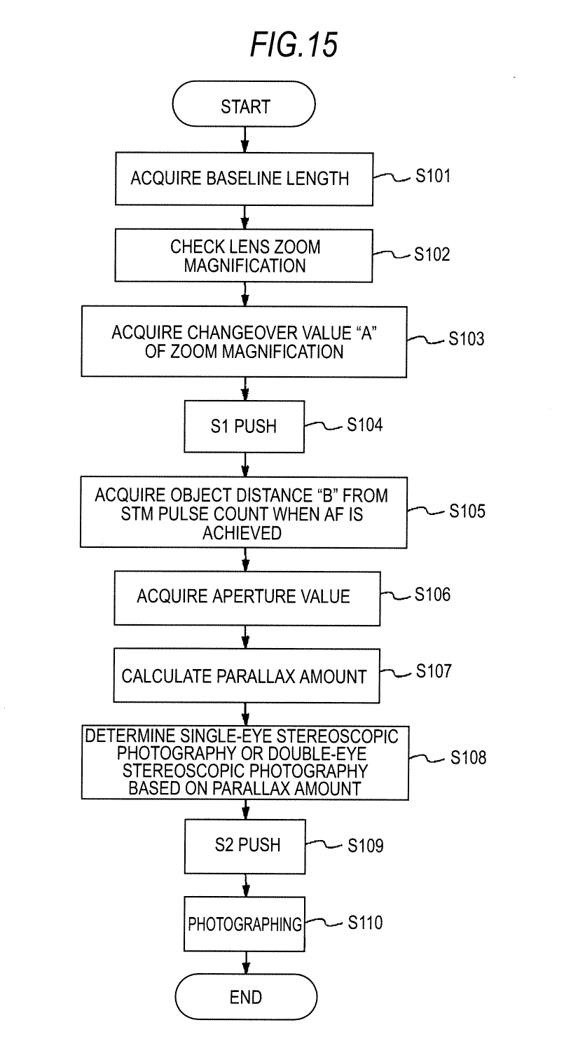

FIG. 15 is a schematic flowchart showing the flow of an example of a photographing process according to the tenth embodiment. This process is executed by the LSI 40M.

In step S101, the LSI 40M acquires the baseline length (pupil-splitting baseline length) of the imaging section 11 (11R, 11L). Since the baseline length has been described in the eighth embodiment, it will not be described further herein. For example, the LSI 40M acquires the baseline length from the EEPROM 46 in which the baseline length is stored in advance.

Steps S102 to S105 are the same as steps S21 to S24 of FIG. 6 in the second embodiment.

In step S106, the LSI 40M acquires an aperture value (also referred to as “F value” or “F number”). The aperture value is determined by the AE detector 44 based on a programmed diagram or the like which is plotted based on a photographic EV value (which represents the brightness of an object). For example, the aperture value may be acquired directly from the AE detector 44 or may be acquired indirectly via the memory 48.

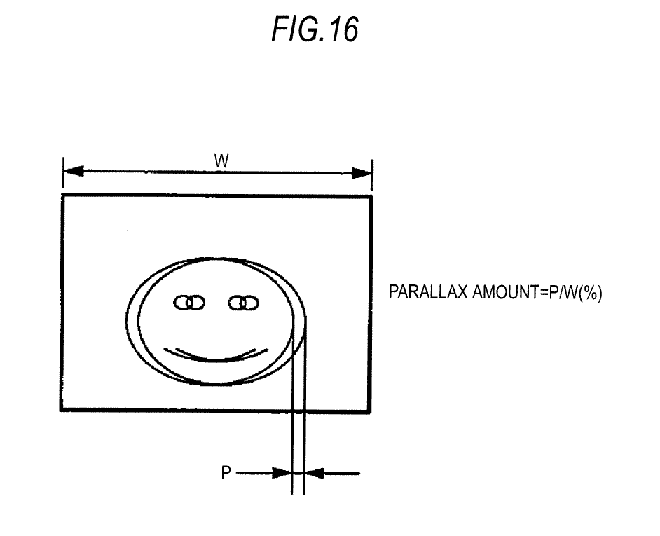

In step S107, the LSI 40M calculates the parallax amount based on a baseline length diagram (SB in FIG. 13) of the imaging section 11, the object distance (focusing object distance) at the focusing position, and the object distance (non-focusing object distance) at the non-focusing position. For example, as shown in FIG. 16, the parallax amount P/W of an object (in this example, the face) image which is formed by the main pixel data (main image) obtained by the main pixel group and the sub-pixel data (sub-pixel image) obtained by the sub-pixel group. In this example, although a normalized value P/W which is obtained by normalizing the pixel-based parallax amount P by the image width W is used, the pixel-based parallax amount P itself may be used.

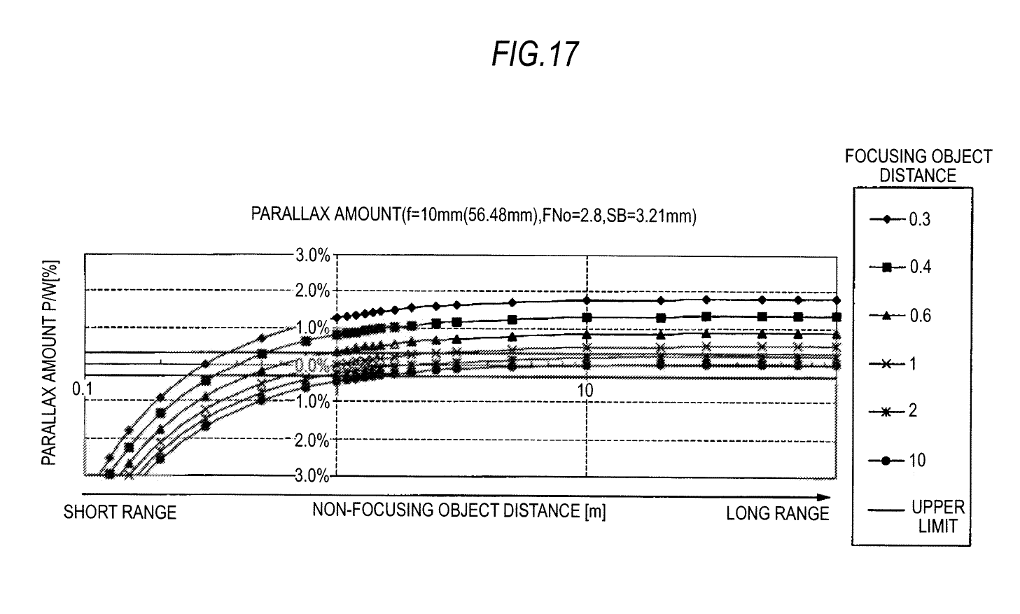

Although the parallax amount can be calculated by various methods, the parallax amount P/W is calculated, for example, based on the focusing object distance, the focal distance f, the aperture value F Number, and the baseline length SB, as shown in FIG. 17. In this example, for the imaging section 11 in which the baseline length SB=3.21 mm, the parallax amount P/W corresponding to the non-focusing object distance is calculated for each focusing object distance.

That is, the parallax amount is calculated based on the focal distance f, the aperture value F number (F value), the baseline length SB, and the focusing position (the position of the focusing lens focusing on a particular object) of the imaging section 11.

In step S108, the LSI 40M switches between the single-eye stereoscopic photography and the double-eye stereoscopic photography based on the calculated parallax amount. For example, the double-eye stereoscopic photography is performed when the parallax amount at the infinite distance is equal to or smaller than a threshold value (in units of %) and the single-eye stereoscopic photography is performed when the parallax amount is larger than the threshold value. The single-eye stereoscopic photography and the double-eye stereoscopic photography may be switched based on the parallax amount at the short range.

Steps S109 and S110 are the same as steps S26 and S27 in the second embodiment.

Note that, while the present invention has been described by way of the first to tenth embodiments, the present invention is not limited to a case where the respective embodiments are implemented independently, but an arbitrary plural number of embodiments may be implemented in combination.

Moreover, the image sensor is not limited to the CCD and an image sensor such as a CMOS sensor may be used.

The present invention is not limited to the examples described in this specification and shown in the drawings, and various changes and improvements in design can be made without departing from the spirit of the present invention.

What is claimed is:

1. A stereoscopic imaging apparatus comprising:
a first imaging section and a second imaging section for imaging an object, and a controlling section for controlling the first imaging section and the second imaging section to obtain a stereoscopic image,
wherein at least one of the first imaging section and the second imaging section has an image sensor which includes a plurality of pixel groups for photo-electrically converting luminous fluxes having passed through different regions of a single photographing optical system for each of the pixel groups, and
the controlling section has a function of double-eye stereoscopic photography in which a viewpoint image obtained by the first imaging section and a viewpoint image obtained by the second imaging section are recorded to a recording medium as the stereoscopic image, and a function of single-eye stereoscopic photography in which a plurality of viewpoint images obtained by the imaging section which includes the plurality of pixel groups among the first imaging section and the second imaging section is recorded to the recording medium as the stereoscopic image.

2. The stereoscopic imaging apparatus according to claim 1,
wherein the first imaging section has the photographing optical system and a general image sensor for photo-electrically converting the luminous fluxes having passed through the photographing optical system without pupil-splitting the luminous fluxes.

3. The stereoscopic imaging apparatus according to claim 1,
wherein the first imaging section and the second imaging section respectively has the photographing optical system and the image sensor including the plurality of pixel groups.

4. A stereoscopic imaging apparatus comprising:
a first imaging section and a second imaging section for imaging an object, and a controlling section for controlling the first imaging section and the second imaging section to obtain a stereoscopic image, a main optical system which is a photographing optical system shared by the first imaging section and the second imaging section; and a beam splitter of a mirror or a prism for splitting luminous fluxes having passed through the main optical system,
wherein the first imaging section and the second imaging section respectively has an imaging optical system for imaging the luminous fluxes split by the beam splitter and an image sensor which includes a plurality of pixel groups for photo-electrically converting the luminous fluxes having passed through different regions of the imaging optical system for each of the pixel groups, and
the controlling section has a function of double-eye stereoscopic photography in which a viewpoint image obtained by the first imaging section and a viewpoint image obtained by the second imaging section are recorded to a recording medium as the stereoscopic image, and a function of single-eye stereoscopic photography in which a plurality of viewpoint images obtained by the imaging section which includes the plurality of pixel groups among the first imaging section and the second imaging section is recorded to the recording medium as the stereoscopic image.

5. The stereoscopic imaging apparatus according to claim 1,
wherein the controlling section determines which one of the single-eye stereoscopic photography and the double-eye stereoscopic photography will be performed based on a photographing condition of the photographing optical system.

6. The stereoscopic imaging apparatus according to claim 5,
wherein the controlling section determines which one of the single-eye stereoscopic photography and the double-eye stereoscopic photography will be performed based on at least one of an optical zoom magnification and object distance.

7. The stereoscopic imaging apparatus according to claim 5,
wherein the controlling section determines which one of the single-eye stereoscopic photography and the double-eye stereoscopic photography will be performed by determining whether a parallax amount of the stereoscopic image in at least one of the single-eye stereoscopic photography and the double-eye stereoscopic photography is suitable or not.

8. The stereoscopic imaging apparatus according to claim 5, further comprising a storage section for storing table information representing the relationship between the photographing condition and the switching of the single-eye stereoscopic photography and the double-eye stereoscopic photography,
wherein the controlling section selects a photography mode corresponding to the photographing condition between the single-eye stereoscopic photography and the double-eye stereoscopic photography based on the table information.

9. The stereoscopic imaging apparatus according to claim 3, further comprising a storage section for storing table information representing the relationship between the photographing condition of the photographing optical system and a plurality of pixel groups used for obtaining the stereoscopic image among the plurality of pixel groups of the first imaging section and the plurality of pixel groups of the second imaging section,
wherein the controlling section selects the pixel groups used for obtaining the stereoscopic image among the plurality of pixel groups of the first imaging section and the plurality of pixel groups of the second imaging section based on the table information.

10. The stereoscopic imaging apparatus according to claim 1,
wherein the controlling section calculates a parallax amount of an object image at a non-focusing position of the stereoscopic image based on at least a pupil-splitting baseline length in the imaging section, an object distance at a focusing position, and an object distance at a non-focusing position and switches between the single-eye stereoscopic photography and the double-eye stereoscopic photography based on the parallax amount.

11. The stereoscopic imaging apparatus according to claim 1,
wherein the controlling section calculates a parallax amount of an object image at a non-focusing position of the stereoscopic image based on at least a pupil-splitting baseline length in the imaging section, a focal distance, an object distance at a focusing position, and an aperture value and switches between the single-eye stereoscopic photography and the double-eye stereoscopic photography based on the parallax amount.

12. The stereoscopic imaging apparatus according to claim 3,
wherein a pupil-splitting baseline length in the first imaging section is different from a pupil-splitting baseline length in the second imaging section, and
when performing the single-eye stereoscopic photography, the controlling section switches between the first imaging section and the second imaging section to generate the stereoscopic image, thus changing the parallax amount of the stereoscopic image.

13. The stereoscopic imaging apparatus according to claim 12,
wherein the controlling section selects the imaging section based on a photographing condition of the photographing optical system.

14. The stereoscopic imaging apparatus according to claim 12, further comprising a photography mode select input section for selecting and inputting a photography mode,
wherein the controlling section selects the imaging section based on the selected photography mode.

15. The stereoscopic imaging apparatus according to claim 10,
wherein the baseline length of the pupil-split is a center-to-center distance between the different regions of the photographing optical system in a plane perpendicular to an optical axis of the photographing optical system.

16. The stereoscopic imaging apparatus according to claim 10,
wherein the image sensor including the plurality of pixel groups includes a microlens for focusing luminous fluxes having passed through the photographing optical system, a photodiode for receiving the luminous fluxes having passed through the microlens, and a light shielding member for partially shielding a light receiving surface of the photodiode, and
the pupil-splitting baseline length is determined by a diameter of the photographing optical system and a light shielding amount of the light receiving surface of the photodiode by the light shielding member.

17. The stereoscopic imaging apparatus according to claim 10,
wherein the image sensor including the plurality of pixel groups includes a microlens for focusing luminous fluxes having passed through the photographing optical system, and a photodiode for receiving the luminous fluxes having passed through the microlens,
an optical axis of the microlens is arranged so as to be shifted from an optical axis of the photodiode, and
the pupil-splitting baseline length is determined by a diameter of the photographing optical system and a shift amount between the optical axis of the microlens and the optical axis of the photodiode.

18. The stereoscopic imaging apparatus according to claim 1, further comprising a photography mode select input section for selecting and inputting a photography mode,
wherein the controlling section determines which one of the single-eye stereoscopic photography and the double-eye stereoscopic photography will be performed in accordance with the selected photography mode.

19. The stereoscopic imaging apparatus according to claim 18,
wherein the controlling section determines to perform double-eye stereoscopic photography when the selected photography mode is a still picture mode or determines to perform the single-eye stereoscopic photography when the selected photography mode is a motion picture mode.

20. The stereoscopic imaging apparatus according to claim 18,
wherein the controlling section determines to perform the single-eye stereoscopic photography when the selected photography mode is a macro mode.

21. The stereoscopic imaging apparatus according to claim 3,
wherein the stereoscopic imaging apparatus is capable of obtaining four viewpoint images using the plurality of pixel groups of the first imaging section and the plurality of pixel groups of the second imaging section, and
when performing the double-eye stereoscopic photography, the controlling section generates the stereoscopic image based on the four viewpoint images.

22. The stereoscopic imaging apparatus according to claim 3,
wherein the stereoscopic imaging apparatus is capable of obtaining four viewpoint images using the plurality of pixel groups of the first imaging section and the plurality of pixel groups of the second imaging section, and
when performing the double-eye stereoscopic photography, the controlling section selects viewpoint images to form the stereoscopic image from the four viewpoint images, thus changing the parallax amount of the stereoscopic image.

23. The stereoscopic imaging apparatus according to claim 3, further comprising a tilt sensor for detecting a tilt of a main body of the stereoscopic imaging apparatus in a plane perpendicular to the optical axis of the photographing optical system of the first imaging section and the second imaging section,
wherein the first imaging section has a plurality of pixel groups for vertical photography divided in a first direction on the light receiving surface on which the luminous fluxes having passed through the photographing optical system are received,
the second imaging section has a plurality of pixel groups for horizontal photography divided in a second direction perpendicular to the first direction on the light receiving surface on which the luminous fluxes having passed through the photographing optical system are received, and
when performing the single-eye stereoscopic photography, the controlling section selects one of single-eye stereoscopic photography for vertical photography using the plurality of pixel groups of the first imaging section and single-eye stereoscopic photography for horizontal photography using the plurality of pixel groups of the second imaging section based on the tilt detected by the tilt sensor.

24. The stereoscopic imaging apparatus according to claim 1,
wherein the controlling section interpolates information lacking in a viewpoint image obtained by a pixel group used for generating the stereoscopic image using a viewpoint image obtained by a pixel group which is not used for generating the stereoscopic image among the plurality of pixel groups of the first imaging section and the plurality of pixel groups of the second imaging section.

25. The stereoscopic imaging apparatus according to claim 1,
wherein when switching between single-eye stereoscopic photography and double-eye stereoscopic photography, the controlling section performs control so that the angle of view in the single-eye stereoscopic photography is identical to that in the double-eye stereoscopic photography.

26. The stereoscopic imaging apparatus according to claim 1,
wherein when switching between single-eye stereoscopic photography and double-eye stereoscopic photography, the controlling section controls a parallax amount of the stereoscopic image to change continuously.

27. The stereoscopic imaging apparatus according to claim 1,
wherein the controlling section performs multi-viewpoint processing based on a plurality of viewpoint images obtained by the first imaging section and the second imaging section.
